(19) United States
(12) Patent Application Publication
(10) Pub. No.: US 2022/0201075 A1
(43) Pub. Date: Jun. 23, 2022

(54) REMOTE DIRECT MEMORY ACCESS (RDMA) TRANSFER OF AN INFORMATION UNIT OVER AN ETHERNET NETWORK

(71) Applicant: HABANA LABS LTD., Tel Aviv-Yafo (IL)

(72) Inventors: Itay Zur, Rosh-Haayin (IL); Ira Joffe, Ramat Yohanan (IL); Guy Hershtig, Caesarea (IL); Amit Pessach, Caesarea (IL); Yanai Pomeranz, Caesarea (IL)

(73) Assignee: HABANA LABS LTD., Tel Aviv-Yafo (IL)

(21) Appl. No.: 17/125,984

(22) Filed: Dec. 17, 2020

(51) Int. Cl. H04L 29/08; G06F 15/173

(52) U.S. Cl. CPC H04L 67/1097; G06F 15/17331

(57) ABSTRACT

Systems, and method and computer readable media that store instructions for remote direct memory access (RDMA) transfers.

### BACKGROUND

High-performance computing systems may include a network of devices such as computing nodes which are connected over a high bandwidth and low latency interconnect. These processing nodes usually run in parallel and require large transfers of data between them.

Each element in the cluster is relatively simple, running only a portion of the computational load.

In computer clusters, each computing node is usually connected to the network with a dedicated network interface card (NIC). Most of the times, there is more than one NIC at each node as each computing node communicates with several other computing nodes. The predominant way is by using standard Ethernet as most of the switches and routers today are Ethernet-based.

RDMA allows direct memory access from a memory of one device into that of another without involving an operating system of any of the devices. The RDMA increases the throughput and reduces the latency of networking.

InfiniBand (IB) is a computer networking communications standard used in high-performance computing that features very high throughput and very low latency. IB is used for data interconnect both among and within computers. InfiniBand is also used as either a direct or switched interconnect between servers and storage systems, as well as an interconnect between storage systems. It is designed to be scalable and uses a switched fabric network topology.

RDMA over Converged Ethernet (RoCE) is a network protocol that allows remote direct memory access (RDMA) over an Ethernet network. It does this by encapsulating an IB transport packet over Ethernet.

The RoCE architecture is based on regular InfiniBand RDMA where each NIC will comprise of several Queue Pairs (QPs) and Work Queues (WQs) associated with those QPs. The queue pairs include input queues and output queues.

RDMA data movement supports linear write (in case of the RDMA write) and linear read (in case of RDMA read).

A work queue (of the WQs) may store at least one Work Queue Element (WQE). Each WQE describes the linear segment of data elements that will be moved between a memory unit of a first device (may be referred to a local device) and a memory unit of a second device (also referred to as a remote device) the remote memory. These memory units are referred to as a local memory unit and a remote memory unit, respectively.

The WQE indicates a start address at the local memory and a start address at the remote memory, which will be either written or read in a linear manner.

FIG. 1 illustrates a prior art WQE 10 that includes the following fields: packet size 11, opcode 12, local address 13 and remote address 14. The local address 13 is the start address of a linear segment of data elements (to be included in an RDMA packet) within the local memory unit, and the remote address 14 is the start address of the linear segment of data elements within the remote memory unit.

Artificial Intelligence (AI) computing may require transferring one or more information units of multiple dimensions. An example of an information unit of multiple dimensions is a tensor—for example, the tensor defined by TensorFlow™. An information unit may include data elements, coefficients, kernel elements, and the like.

An information unit of multiple dimensions is stored in a multidimensional manner—and not in a single linear segment of data units.

The current solution for transferring information unit of multiple dimensions includes:
Splitting the information unit of multiple dimensions, by a time-consuming software executed by a host computer, The information unit of multiple dimensions is split to linear segments of a first dimension.
Assigning a dedicated WQE for each linear segment.
Executing the WQE by generating an RDMA packet per each linear segment.
Transmitting the RDMA packet.
Receiving the RDMA packet.
Storing the liner segment in memory.

This solution is highly inefficient—and may amount in significant processing resources and transmission resources overheads.

There is a growing need to provide a more efficient method for transmission of information unit of multiple dimensions.

### SUMMARY

There may be provided systems, methods, and computer readable medium as illustrated in the specification.

There may be provided a method for RDMA transfer of an information unit of multiple dimensions. The method may include generating an RDMA packet that comprises a part of the information unit, the part of the information unit comprises data elements read by following a part of a scan pattern, the scan pattern has the multiple dimensions; sending scan metadata from a first device to the second device; and transferring the RDMA packet from a first device to a second device, and over an Ethernet network path.

There may be provided a non-transitory computer readable medium for RDMA transfer of an information unit of multiple dimensions, the non-transitory computer readable medium may store instructions for: generating an RDMA packet that comprises a part of the information unit, the part of the information unit comprises data elements read by following a part of a scan pattern, the scan pattern has the multiple dimensions; sending scan metadata from a first device to the second device; and transferring the RDMA packet from a first device to a second device, and over an Ethernet network path.

There may be provided a network interface card for RDMA transfer of an information unit of multiple dimensions, the network interface card may include an RDMA module, the RDMA module may include an RDMA controller. The RDMA module may be configured to: generate an RDMA packet that comprises a part of the information unit, the part of the information unit comprises data elements read by following a part of a scan pattern, the scan pattern has the multiple dimensions; send scan metadata from a device that comprises the network interface card to an other device; and transfer the RDMA packet over an Ethernet network path from the device that comprises the network interface card to the other device.

### BRIEF DESCRIPTION OF THE DRAWINGS

The embodiments of the disclosure will be understood and appreciated more fully from the following detailed description, taken in conjunction with the drawings in which:

FIG. 1 illustrates a prior art work queue entity;

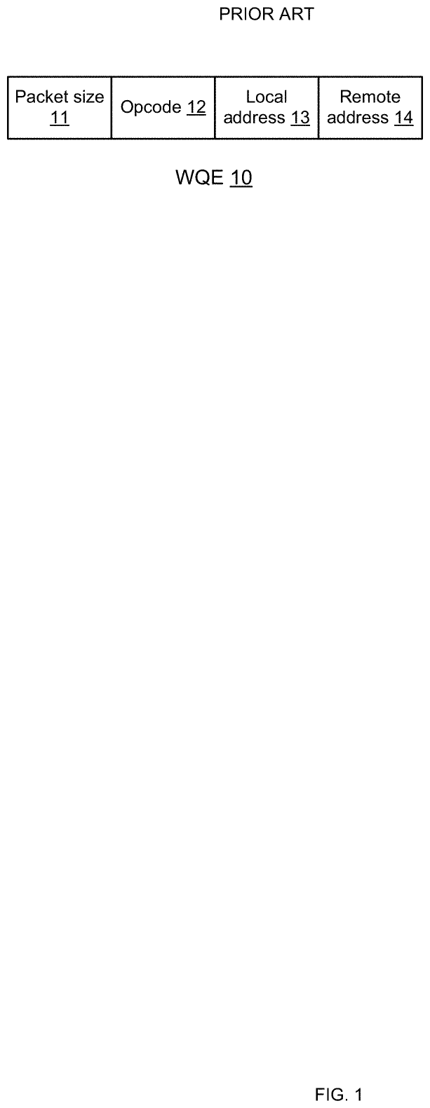

FIG. 2 illustrates an example of a multidimensional transfer work queue entity and of an RDMA packet;

FIG. 3 illustrates an example of an information unit of multiple dimensions and of a scan pattern of multiple dimensions;

FIG. 4 illustrates an example of a first part of the information unit of multiple dimensions by a part of a scan pattern of multiple dimensions;

FIG. 5 is an example of a method; and

FIG. 6 is an example of an Ethernet network, a first device, and a second device.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system or a network interface card capable of executing the method and/or to a non-transitory computer readable medium that stores instructions for executing the method.

Any reference in the specification to a system or device (or a network interface card) should be applied mutatis mutandis to a method that may be executed by the system (or the device or the network interface card), and/or may be applied mutatis mutandis to non-transitory computer readable medium that stores instructions executable by the system.

Any reference in the specification to a non-transitory computer readable medium should be applied mutatis mutandis to a device or system or network interface card capable of executing instructions stored in the non-transitory computer readable medium and/or may be applied mutatis mutandis to a method for executing the instructions.

Any combination of any module or unit listed in any of the figures, any part of the specification and/or any claims may be provided.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

There may be provided a method, a system, and a non-transitory computer readable medium for transferring information units of multiple dimensions in an efficient manner.

An information unit of multiple dimensions is stored in a memory unit in a non-liner manner.

The multiple dimensions include a first dimension and one or more additional dimensions. The information unit includes multiple linear sections of a first size that are arranged along the first dimension and are spread over the additional dimensions.

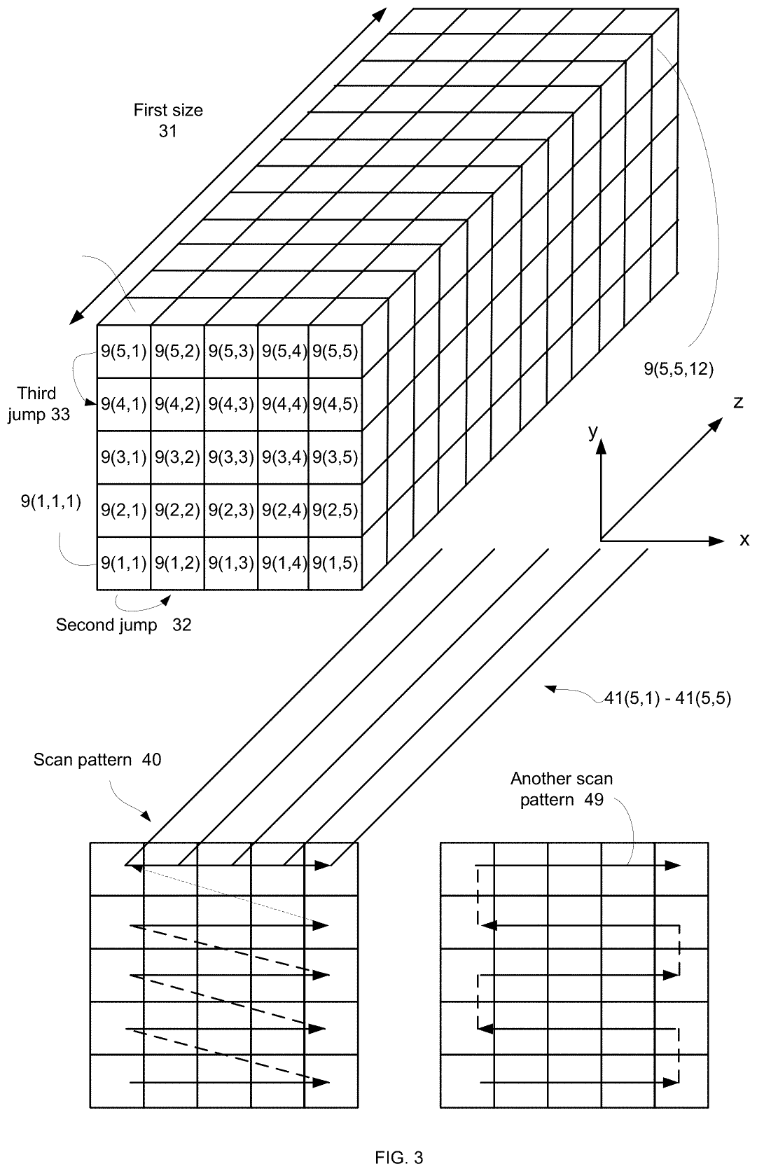

For example—referring to FIG. 3—the first dimension is the Z-axis and each linear section is arranged along the Z axis. It is assumed that the Z-axis information elements can be sequentially read from the local memory unit. The different linear sections are arranged along the X axis and the Y axis.

The information unit is stored in a virtual multidimensional space and can be read by following a scan pattern having the multiple dimensions. Scanning the information using by following the scan pattern may include sequentially reading information elements of a single linear segment and jumping between the one linear sequence to another. The jumping usually is done along one dimension—until reaching an edge of the information unit along that dimension—and then jumping along another dimension.

The information unit may be too big to be included in a single RDMA packet—so that different parts of an information unit may be packed in different RDMA packets.

Each part of the information unit is read by following a part of the scan pattern.

In order to support the reconstruction, by a receiving device, of an information unit part of an RDMA packet—the second device should be aware of the location of the part of the scan pattern (corresponding to the locations of the information elements within the information unit)—and this can be done, for example, by sending (by the first device) scan metadata that may include a scan part location metadata.

The scan part location metadata may not be required where the order of RDMA packets is maintained—but may be required when receiving RDMA packets out of order.

The scan metadata related to an information unit may be included in one or more RDMA packets that convey one or more parts of the information unit—or may be located outside these one or more RDMA packets.

For simplicity of explanation it is assumed that an RDMA packets that includes a part of an information unit includes scan metadata such as scan part location metadata.

The scan part location metadata is indicative of a location of the part of the scan pattern—for example the first information that should be read when following the part of the scan pattern. The scan part location metadata may be included in the RDMA packet.

The scan part location metadata may be regarded as state metadata and both first device and second device may track after the state of transmission (or reception) of the RDMA packets—especially when out of order reception of the RDMA packets exists.

The scan part location metadata is highly beneficial when the RDMA packets may be received by the second device out of order. The second device may track, regardless of the order of arrival, after the RDMA packets and store a received part of the information unit regardless previously received parts of the information unit.

The reconstruction may also require a knowledge of the scan pattern. The scan pattern is represented by scan pattern metadata.

The scan pattern metadata may include:
The first size (of the linear segment).
A number of linear sections per each of the additional dimensions.
A jump size between linear sections per each of the additional dimensions.

Any other representation of the scan pattern may be provided.

The scan pattern metadata may be sent with each RDMA packet—thereby allowing the second device to reconstruct the scan pattern based on the received RDMA packet alone—thereby saving memory resources of the second device.

On the other hand—if the second device is configured to store the scan pattern metadata between the reception of RDMA packets related to the same information unit—then the scan pattern metadata does not need to be sent every RDMA packet.

There may be provided a multidimensional transfer WQE that may include the scan pattern metadata, a local address (for example first address of the information unit in the local memory unit) and remote address (for example first address of the information unit in the remote memory unit).

The execution of the multidimensional transfer WQE results in a transmission of an information unit of multiple dimensions in a highly efficient manner.

The information elements retrieved by a part of the scan pattern may be concatenated—or otherwise send as a single sequence of information elements within the RDMA packet.

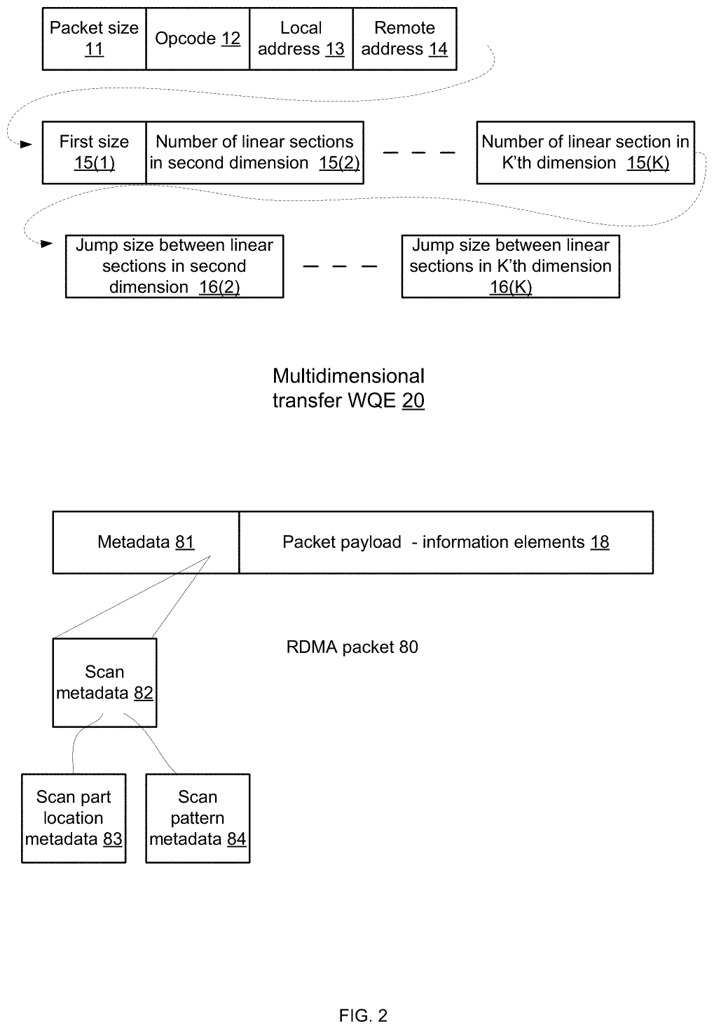

FIG. 2 is an example of the multidimensional transfer WQE 20 and of RDMA packet 80.

It is assumed that there are K dimensions (K being an integer that may be two—but it is assumed that K exceeds two). The K'th dimensions include the first dimension and (K−1) additional dimensions—from the second dimension till the K'th dimension.

Multidimensional transfer WQE 20 includes the following fields—packet size 11, opcode 12, local address 13, remote address 14, the first size (of the linear segment) 15(1), a number of linear sections per each of the additional dimensions—15(2)-15(K), and the jump size between linear sections per each of the additional dimensions—16(2)-16(K).

RDMA packet 80 includes metadata 81 and packet payload—information elements of an entire information unit or only of a part of the information unit.

The metadata may be included in a header, in a footer or in any other location. The RDMA packet may include additional metadata—for example communication protocol headers, error correction metadata and the like.

The metadata 81 may include scan metadata 82 that in turn may include scan part location metadata 83. The scan metadata may also include scan pattern metadata 84. As indicated above—the scan metadata (or any part of) may not be included in the RDMA packet.

FIG. 3 is an example of an information unit 9 that is three dimensional.

The information unit includes five by five linear sections denoted 9(1,1)-9(5,5)—each spans along the Z axis and includes twelve information units.

There are 5×5×12 information elements—from 9(1,1,1) to 9(5,5,12).

The information unit 9 is scanned by a scan pattern 40 that is three dimensional.

Scanning the information using the scan pattern includes: reaching a linear section, scanning the liner section (along the Z axis) and jumping to the next linear section. The jumping is done within a row (along the X axis)—and once the entire row is scanned—jumping to the next row (along the Y axis).

The scan pattern 40 scans information elements of a liner section—one linear segment after the other (see for example scan lines 41(5,1)-41(5,5) for scanning the five upper linear segments), and then row by row—wherein each row is scanned from left to right.

Other scan patterns may be applied—for example—see additional scan pattern 49 in which odd rows are scanned from left to right and even rows are scanned from right to left.

The linear sections may be scanned one column after the other or in any other manner.

The jump along the X axis is denoted second jump 32 and the jump along the Y axis is denoted third jump 33.

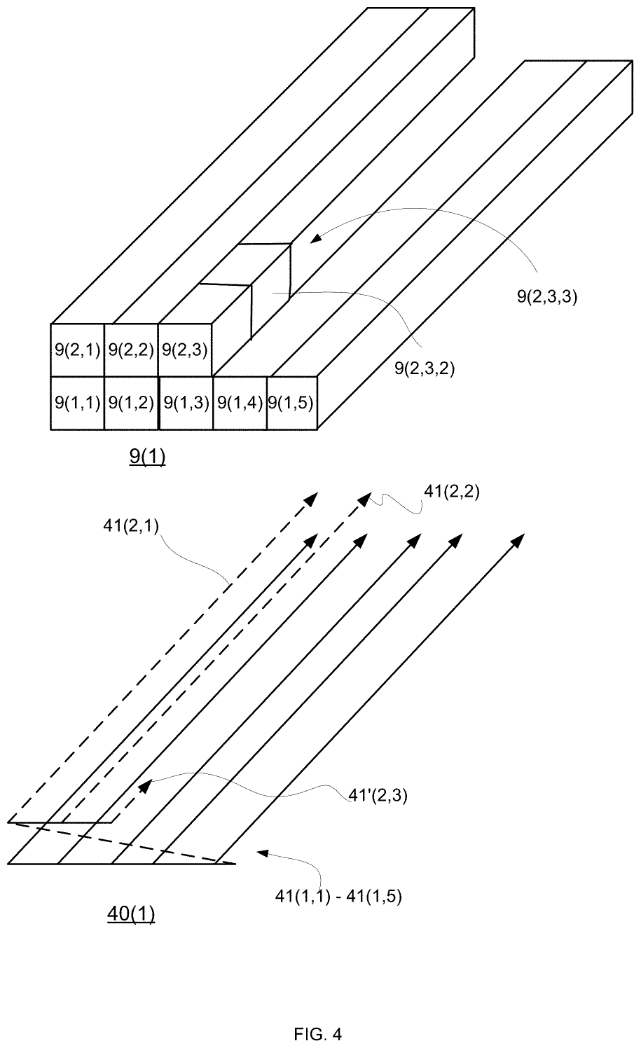

FIG. 4 illustrates an example in which only a first part 9(1) of information unit 9 is included in an RDMA packet—this RDMA packet is obtained by following a first part 40(1) of the scan pattern 40.

The first part 40(1) of scan pattern 40 includes:
Fully scanning (see full scan lines 41(1,1)-41(1,5) and 41(2,1)-41(2,2) linear sections 9(1,1)-9(1,5) and 9(2,1)-9(2,2).
Partially scanning (till reaching information unit 9(2,3,2)) the linear section 9(2,3)—as illustrated by partial scan line 41′(2,3).

The next part of information unit will start at the next information element 9(2,3,3).

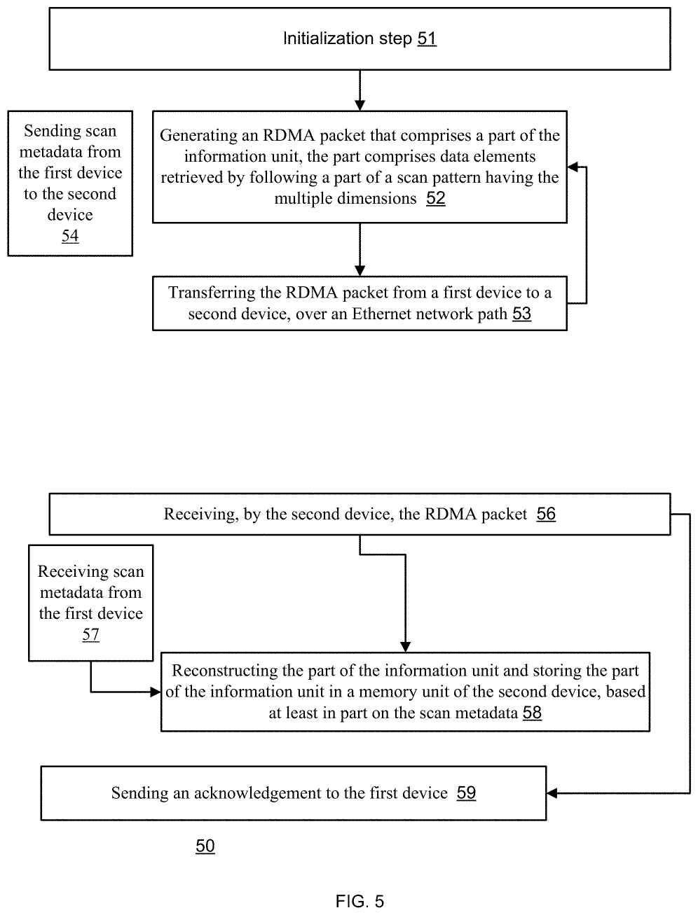

FIG. 5 illustrates method 50 for remote direct memory access (RDMA) transfer of an information unit of multiple dimensions.

Method 50 may include initialization step 51.

Step 51 may be followed by step 52 of generating an RDMA packet that may include a part of the information unit. The part of the information unit may include data elements retrieved by following a part of a scan pattern having the multiple dimensions.

The scan metadata may or may not be included in the RDMA packet. The scan metadata include a scan part location metadata that is indicative of a location of the part of the scan pattern.

For example—it may include the offset, in each dimension, of the first information unit scanned by the part of the scan pattern. In FIG. 4—the first part 40(1) of the scan pattern starts at information element 9(1,1,1)—and all offsets are zero. The second part (not shown) of the scan pattern starts at information element 9(2,3,3) and the offsets will be 1, 2 and 2.

Step 52 may be followed by step 53 of transferring the RDMA packet from a first device to a second device, and over an Ethernet network path.

The information unit may include multiple linear sections of a first size that are arranged along the first dimension and span over the additional dimensions.

The scan metadata of the RDMA packet may include scan pattern metadata for reconstructing the scan pattern by the second device.

The scan pattern has a first dimension and additional dimensions that correspond to the dimensions of the information unit.

The scan pattern metadata of the RDMA packet may include the first size, a number of linear sections per each of the additional dimensions, and a jump size between linear sections per each of the additional dimensions.

Method 50 may include step 54 of sending scan metadata from the first device to the second device.

If the scan metadata is included in the RDMA packet then step 54 may be regarded as part of step 53. Else—the scan metadata (or part of the scan metadata) is not included in the RDMA packet—then step 53 is not a part of step 54.

The information unit may include multiple parts and steps 52 and 53 may be repeated multiple times—one per each pat of the information unit.

During the multiple repetitions of steps 52, 53 and 54—the scan pattern metadata for reconstructing the scan pattern by the second device may transmitted once, during some of the repetitions or during each repetition.

Initialization step 51 may include receiving, by a network interface controller of the first device a command to transfer the information unit to the second device, the command may include a definition of the scan pattern.

The command may be a multidimensional transfer work queue element.

Steps 51, 52, 54 and 54 may be executed by the first device.

The second device may execute steps 56, 57, 58 and 59.

Step 56 may include receiving, by the second device, the RDMA packet.

Step 57 may include receiving the scan metadata from the first device. Step 57 may belong to step 56.

Steps 56 and 57 may be followed by steps 58 and 59.

Step 58 may include reconstructing the part of the information unit and storing the part of the information unit in a memory unit of the second device, based at least in part on the scan metadata.

The reconstruction may include determining the scan pattern, determining the start of a current part of the scan pattern—and writing to the remote memory unit (according to the scan pattern and the start of the part of the scan pattern) the information elements.

For example—referring to FIG. 3—when receiving the RDMA packet that was generated by first part 40(1) of scan pattern—the information elements are written to the remote memory unit—starting at a location allocated to information element 9(1,1,1) and ending at information element 9(2,3,2).

For example—referring to FIG. 3—when receiving the RDMA packet that was generated by second part 40(2) of scan pattern—the information elements are written to the remote memory unit—starting at a location allocated to information element 9(2,3,3).

Step 59 may include sending an acknowledgement to the first device.

The scan pattern may be generated by having multiple nested loops—one nested loop per dimension—and tracking after the progress (by tracking after the value of loop counters—one loop counter per dimension).

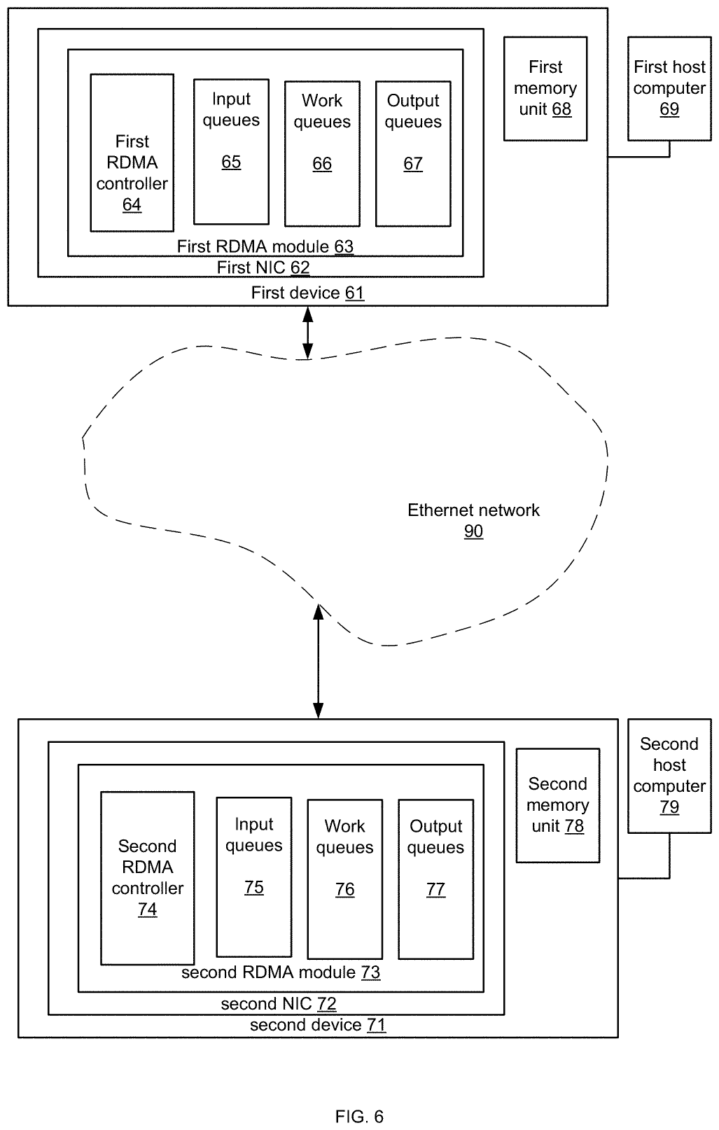

FIG. 6 illustrates an Ethernet network 90 that is coupled to the first device 61 and the second device 71.

The first device 61 includes a first NIC 61, and first memory unit 68. The first NIC 61 includes first RDMA module 63 that includes first RDMA controller 64, input queues 65, work queues 66 and output queues 67. The first device 61 may communicate with first host computer 69.

The second device 71 includes a second NIC 71, and a second memory unit 78. The second NIC 71 includes second RDMA module 73 that includes second RDMA controller 74, input queues 75, work queues 77 and output queues. The second device 71 may communicate with second host computer 79.

The first RDMA module 63 and the second RDMA module 73 are configured to manage RDMA communication—including the retrieval of an information unit of multiple dimensions, the generation of RDMA packets, the reception of RDMA packets, and reconstruction and storage of the information unit.

The first RDMA controller 64 may control the operation of the first RDMA module 63. The second RDMA controller 74 may control the operation of the second RDMA module 73.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Any reference to “having” and “comprising” may be applied, mutatis mutandis to “consisting” and/or “consisting essentially of”.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

We claim:

1. A method for remote direct memory access (RDMA) transfer of an information unit of multiple dimensions, the method comprising:
generating an RDMA packet that comprises a part of the information unit, the part of the information unit comprises data elements read by following a part of a scan pattern, the scan pattern has the multiple dimensions;
sending scan metadata from a first device to the second device; and
transferring the RDMA packet from a first device to a second device, and over an Ethernet network path.

2. The method according to claim 1 wherein the scan metadata comprises a scan part location metadata that is indicative of a location of the part of the scan pattern.

3. The method according to claim 1 wherein at least a part of the scan metadata is included in the RDMA packet.

4. The method according to claim 1 wherein at least a part of the scan metadata is not included in the RDMA packet.

5. The method according to claim 1 wherein the information unit has a first dimension and additional dimensions, wherein the information unit comprises multiple linear sections of a first size that are arranged along the first dimension and span over the additional dimensions.

6. The method according to claim 5 wherein the scan pattern has a first dimension and additional dimensions, wherein the scan metadata further comprises scan pattern metadata, the scan pattern metadata comprises the first size, a number of linear sections per each of the additional dimensions, and a jump size between linear sections per each of the additional dimensions.

7. The method according to claim 1 wherein the scan metadata further comprises scan pattern metadata for reconstructing the scan pattern by the second device.

8. The method according to claim 1 wherein the information unit comprises multiple parts, wherein the method comprises repeating, for each part of the multiple parts, the generating of the RDMA packet and the transmitting of the RDMA packet.

9. The method according to claim 8 comprising transmitting, for each one of the multiple parts, scan metadata that comprises scan pattern metadata for reconstructing the scan pattern by the second device.

10. The method according to claim 8 comprising transmitting, for only a part of the multiple parts, scan metadata that comprises scan pattern metadata for reconstructing the scan pattern by the second device.

11. The method according to claim 8 wherein the generating of any of the RDMA packets is preceded by receiving, by a network interface controller of the first device a command to transfer the information unit to the second device, the command comprises a definition of the scan pattern.

12. The method according to claim 11 wherein the command is a multidimensional transfer work queue element.

13. The method according to claim 1
comprising: receiving, by the second device, the
RDMA packet; and
reconstructing the part of the information unit and storing the part of the information unit in a memory unit of the second device, based at least in part on the scan metadata.

14. A non-transitory computer readable medium for remote direct memory access (RDMA) transfer of an information unit of multiple dimensions, the non-transitory computer readable medium stores instructions for:
generating an RDMA packet that comprises a part of the information unit, the part of the information unit comprises data elements read by following a part of a scan pattern, the scan pattern has the multiple dimensions;
sending scan metadata from a first device to the second device; and
transferring the RDMA packet from a first device to a second device, and over an Ethernet network path.

15. A network interface card for remote direct memory access (RDMA) transfer of an information unit of multiple dimensions, the network interface card comprises an RDMA module, the RDMA module comprises an RDMA controller, wherein the RDMA module is configured to:
generate an RDMA packet that comprises a part of the information unit, the part of the information unit comprises data elements read by following a part of a scan pattern, the scan pattern has the multiple dimensions;
send scan metadata from a device that comprises the network interface card to an other device; and
transfer the RDMA packet over an Ethernet network path from the device that comprises the network interface card to the other device.

16. The network interface according to claim 15 wherein the information unit comprises multiple parts, wherein the method comprises repeating, for each part of the multiple parts, the generating of the RDMA packet and the transmitting of the RDMA packet; wherein the generating of any of the RDMA packets is preceded by receiving, by a network interface controller of the first device a command to transfer the information unit to the second device, the command comprises a definition of the scan pattern; wherein the command is a multidimensional transfer work queue element; and wherein the multidimensional transfer work queue element comprises a packet size field, an opcode field, a local address field, a remote address field, a first size field indicative of a size of a linear segment, a first sequence of fields that include a number of linear sections per each dimension of the multiple dimensions other than the first dimension, a second sequence of fields that include a jump between linear dimensions per field of each dimension of the multiple dimensions other than the first dimension.

17. The network interface according to claim 15 wherein the multiple dimensions comprise at least three dimensions.

18. The non-transitory computer readable medium according to claim 14 wherein the information unit comprises multiple parts, wherein the method comprises repeating, for each part of the multiple parts, the generating of the RDMA packet and the transmitting of the RDMA packet; wherein the generating of any of the RDMA packets is preceded by receiving, by a network interface controller of the first device a command to transfer the information unit to the second device, the command comprises a definition of the scan pattern; wherein the command is a multidimensional transfer work queue element; and wherein the multidimensional transfer work queue element comprises a packet size field, an opcode field, a local address field, a remote address field, a first size field indicative of a size of a linear segment, a first sequence of fields that include a number of linear sections per each dimension of the multiple dimensions other than the first dimension, a second sequence of fields that include a jump between linear dimensions per field of each dimension of the multiple dimensions other than the first dimension.

19. The method according to claim 12 wherein the multidimensional transfer work queue element comprises a packet size field, an opcode field, a local address field, a remote address field, a first size field indicative of a size of a linear segment, a first sequence of fields that include a number of linear sections per each dimension of the multiple dimensions other than the first dimension, a second sequence of fields that include a jump between linear dimensions per field of each dimension of the multiple dimensions other than the first dimension.

20. The method according to claim 1 wherein the multiple dimension comprises at least three dimensions.
